(19) United States
(12) Patent Application Publication
(10) Pub. No.: US 2007/0187448 A1
(43) Pub. Date: Aug. 16, 2007

(54) Utility bracket

(76) Inventors: Michael E. Dongiovanni, Apollo, PA (US); Theresa M. Dongiovanni, Apollo, PA (US)

Correspondence Address: JAMES RAY & ASSOCIATES, 2640 PITCAIRN ROAD, MONROEVILLE, PA, 15146, US

(21) Appl. No.: 11/506,848

(22) Filed: Aug. 18, 2006

Related U.S. Application Data
(60) Provisional application No. 60/772,171, filed on Feb. 10, 2006.

(51) Int. Cl. B62J 9/00; B60R 11/00; B60R 9/00

(52) U.S. Cl. 224/520; 224/526; 224/413

(57) ABSTRACT

An apparatus for providing additional storage for use with a motorcycle. The apparatus comprises a base member having a predetermined shape and formed of a predetermined material. A plurality of upright sections are engageable on a first end with the base member. A top member is engageable with an upper surface of a second end of the plurality of upright sections and a connecting unit that is engageable with the base member is designed for securing the apparatus to a hitch of a motorcycle.

### CROSS REFERENCE TO RELATED APPLICATIONS

This application is closely related to and claims benefit from U.S. Provisional Application Ser. No. 60/772,171 filed Feb. 10, 2006.

### FIELD OF THE INVENTION

The present invention relates, in general, to a carrier for a at least one of a motorcycle, automotive type vehicle and preselected tractors and, more particularly, the present invention relates to a carrier which when attached to a hitch on a motorcycle which can provide added cargo space and conserve energy by using a motorcycle as opposed to a larger vehicle for a number of tasks such as shopping, carrying a golf bag, etc.

### BACKGROUND OF THE INVENTION

It is estimated that there are an estimated 8.8 million motorcycles currently in use in the United States. Since 1998 there has been a 34 percent increase in the number of motorcycles in use. With these figures it is easy to conclude that with rise in sales that the trend toward motorcycle riding is very much on the upswing.

Further, with the increased price of gasoline this trend will likely rise even faster since it does not seem that the gasoline prices will decrease in the foreseeable future and there is no question that the miles per gallon achieved by a motorcycle is clearly significantly better than for even the most economical automobiles. There is one major drawback to the use of motorcycles that has kept the use of motorcycles from increasing even faster and that is the lack of storage space. Normally motorcycles are equipped with what could be referred to as saddle bags that are strapped to the back of the cycle. Since this storage area is quite limited it is difficult to carry much in the way of cargo. Also, for those sports enthusiasts that enjoy golf, fishing or hunting the storage area is so limited that many times it is impractical to take the motorcycle for these sports. There is no room to carry golf clubs and even fishing gear presents a problem.

Thus, it would be advantageous if there were a way to increase the cargo space so that the motorcycle can be used for longer trips without the need of doing a load of laundry, or for the sporting enthusiasts. A golfer who rides a motorcycle would certainly welcome the ability to carry his clubs safely on the bike.

### SUMMARY OF THE INVENTION

In a first aspect the present invention provides an apparatus for providing additional storage for use with a motorcycle. The apparatus comprises a base member having a predetermined shape and formed of a predetermined material. A plurality of upright sections are engageable on a first end with the base member. A top member is engageable with an upper surface of a second end of the plurality of upright sections and a means is engageable with the base member for securing the apparatus to a hitch of a motorcycle.

In a second aspect the present invention provides an apparatus for connecting a storage compartment to a hitch disposed on at least one of a motorcycle, an automotive type vehicle and a tractor. The apparatus comprises an elongated C-shaped channel member having each of a predetermined length and a predetermined width, each leg of the elongated C-shaped channel member having a predetermined width. A first means is disposed at one end on an inner surface of each leg of the C-shaped channel member for preventing vertical movement of the storage compartment attached to an upper surface of the C-shaped channel member during use and there is a second means disposed closely adjacent one end of the elongated C-shaped channel member for securing the elongated C-shaped channel member to such hitch disposed on at least one of a motorcycle, an automotive type vehicle and a tractor.

In yet another aspect of the invention there is provided in combination with a hitch disposed on at least one of an automotive type vehicle and a tractor an apparatus for providing additional storage. The apparatus comprises a base member having a predetermined shape and formed of a predetermined material. A plurality of wall members are engageable with the base member and there is a means engageable with the base member for securing the apparatus to a hitch of such at least one of one an automotive type vehicle and a tractor.

### OBJECTS OF THE INVENTION

It is, therefore, one of the primary objects of the present invention to provide a storage unit for a motorcycle that would provide additional storage.

Another object of the present invention is to provide a storage unit for a motorcycle that could be used to carry a golf bag and clubs.

Still another object of the present invention is to provide a storage unit for a motorcycle that could be used to carry other long items like fishing poles, hunting equipment, or baseball bats.

Yet another object of the present invention is to provide a storage unit for a motorcycle that could be used to carry additional items that could be safely secured therein.

It is yet another object of the present invention to provide a storage unit for a motorcycle that would be relatively inexpensive to produce.

Another object of the present invention is to provide an apparatus for connecting a storage compartment to at least one of a motorcycle, an automotive type vehicle and a tractor.

Still another object of the present invention is to provide a modification of a unit connecting to a hitch on one of a motorcycle, automotive type vehicle and a tractor for preventing vertical movement of the storage compartment.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of a prior art hitch connection for a motor cycle.

FIG. 2 is a perspective view of the apparatus for providing additional storage for connecting to such ball type motorcycle hitch.

FIG. 3 is a perspective view of the underside of the apparatus shown in FIG. 2

FIG. 4 is enlarged view of the connecting member for connecting to a ball hitch disposed on a motorcycle.

FIG. 5 is a perspective view of the apparatus for providing additional storage for connecting to a pin type hitch on a motorcycle.

FIG. 6 is a perspective view of the underside of a connecting member for a storage unit showing a stabilizer bar.

FIG. 7 is enlarged view of the connecting member for connecting to a ball hitch disposed on a motorcycle wherein the connecting member is provided with a stabilizer bar.

FIG. 8 is a perspective view of the apparatus for providing additional storage for connecting to a pin type hitch on a motorcycle showing a different storage member.

FIG. 9 is a perspective view of the apparatus for providing additional storage for connecting to a pin type hitch on a motorcycle showing yet another type of storage member.

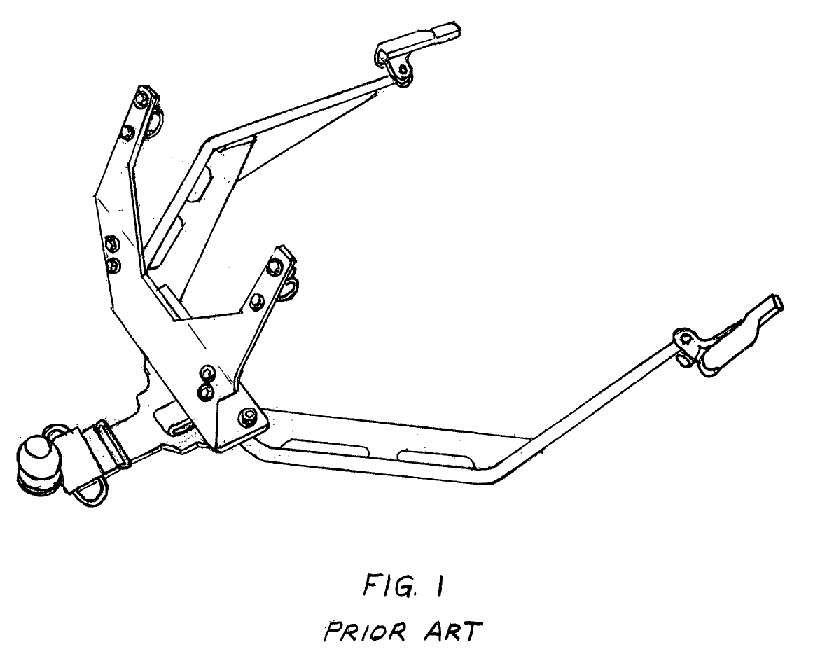

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for providing additional storage for use with a motorcycle (not shown). The apparatus 10 comprises a base member 2 having a predetermined shape and formed of a predetermined material. A plurality of upright sections 4 are engageable on a first end with the base member 2. A top member 6 is engageable with an upper surface of a second end of the plurality of upright sections 4 and a means, generally designated 20, is engageable with the base member 2 for securing the apparatus 10 to a hitch 12 of a motorcycle.

The predetermined shape of the base member 2 of such apparatus 10 is one of rectangular, hexagonal, octagonal and circular. It is presently preferred that such predetermined shape is substantially circular.

The predetermined shape of the base member 2 of the apparatus 10 further includes an upwardly extending lip member 12 that is formed integrally therewith. The plurality of upright sections 4 are engageable with an inner surface of the lip member 12 and the bottom portion of the upright sections 4 are engageable with the upper surface of the base member 2. These upright sections 4 are disposed substantially uniformly around a perimeter of the base member 2.

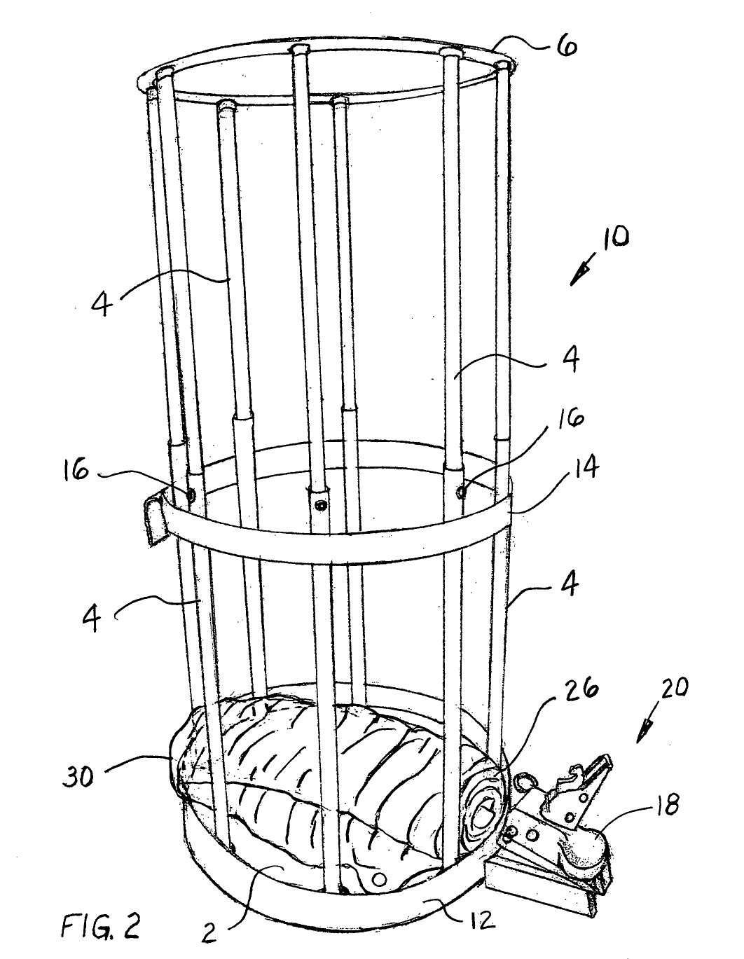

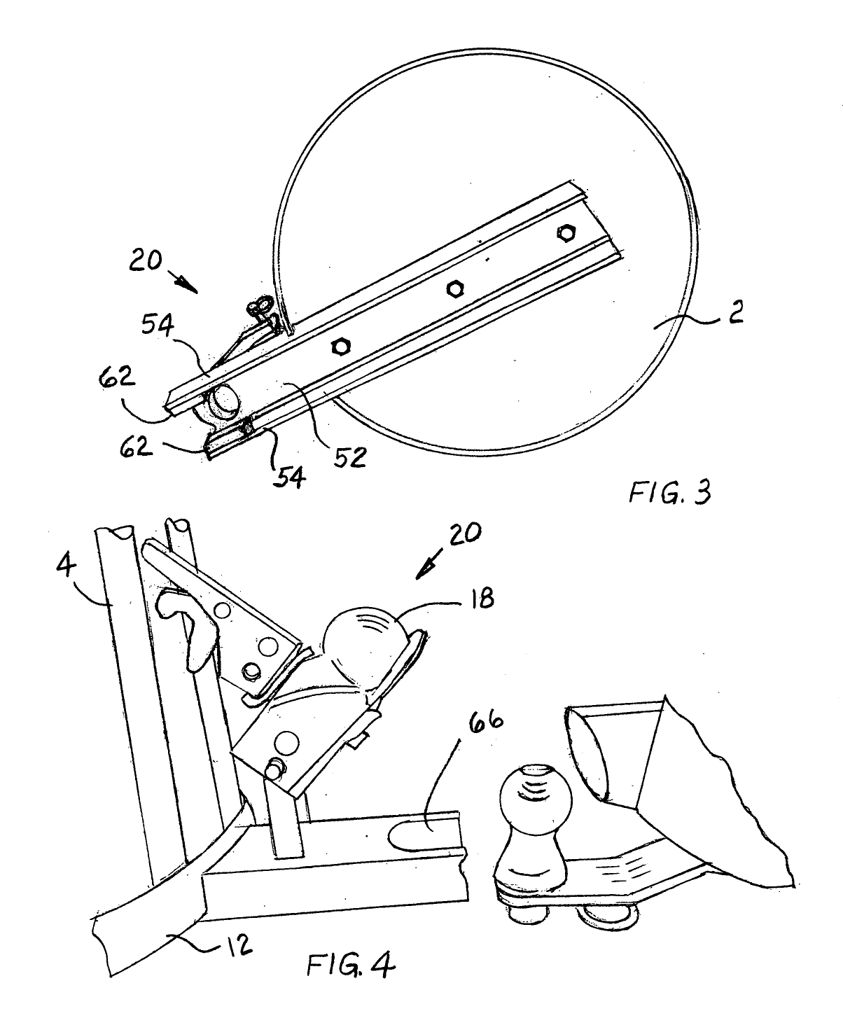

As is evident in FIG. 2 such upright sections 4 are telescoping. In this manner the sections can be kept at the low position when not carrying any large objects and can be extended to the top when carrying some large items such as a golf bag including the clubs. The upright sections 4 include snap buttons 16 to control the telescoping.

The apparatus further includes a supporting member 14, the supporting member 14 being a band having a predetermined width engageable with an outer surface of the plurality of upright sections 4 at a distance intermediate the base member 2 and the top member 6.

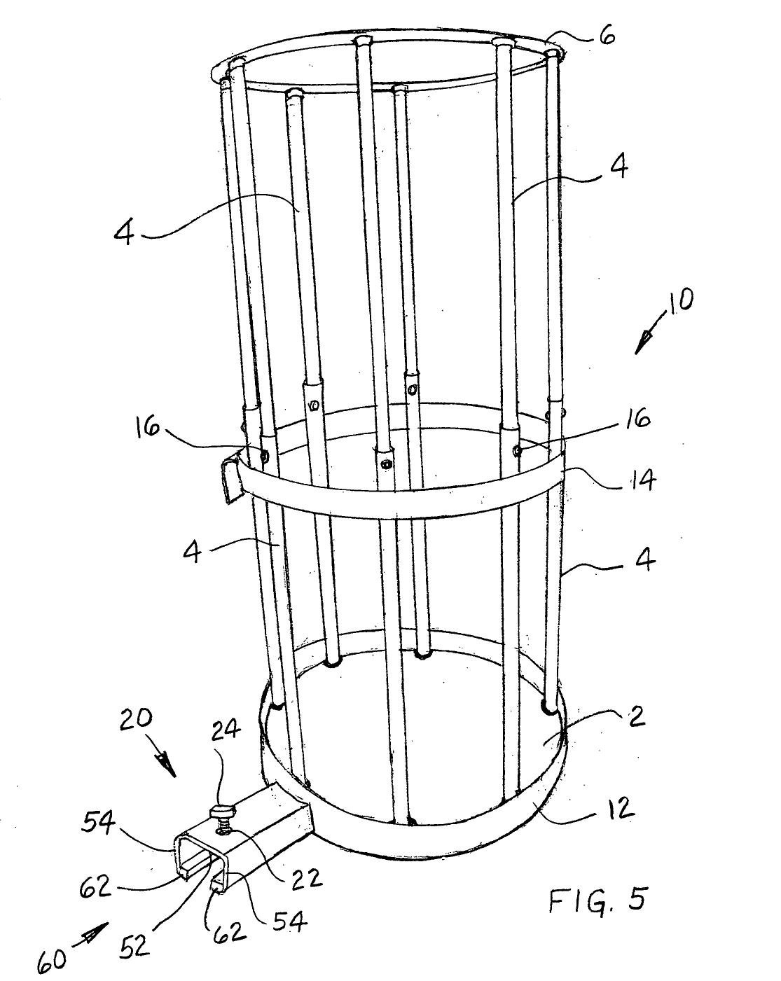

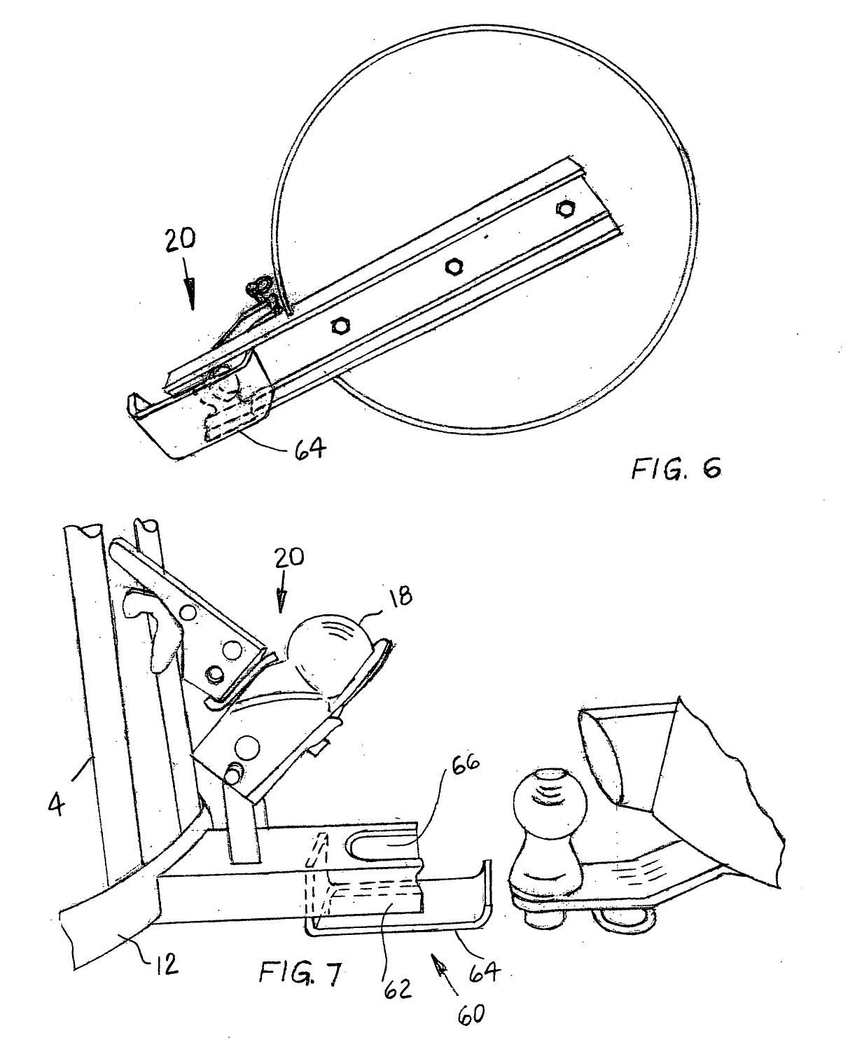

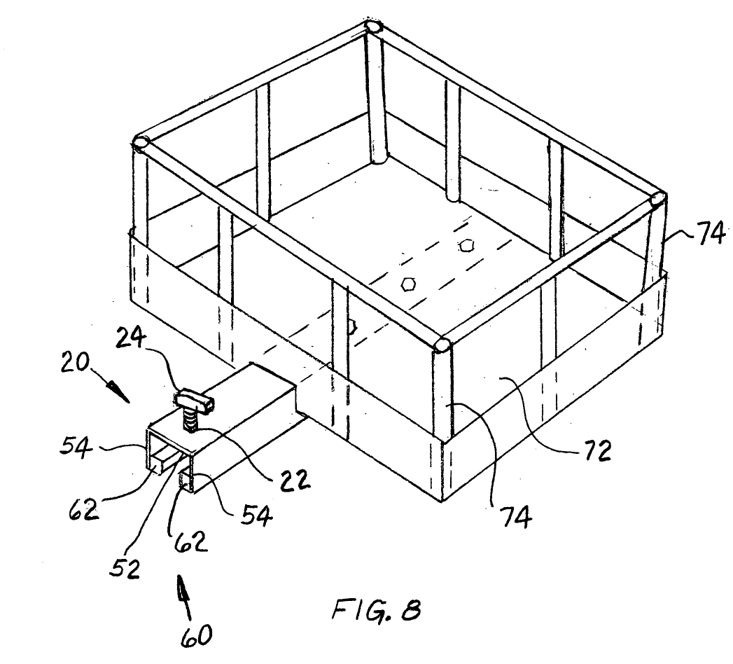

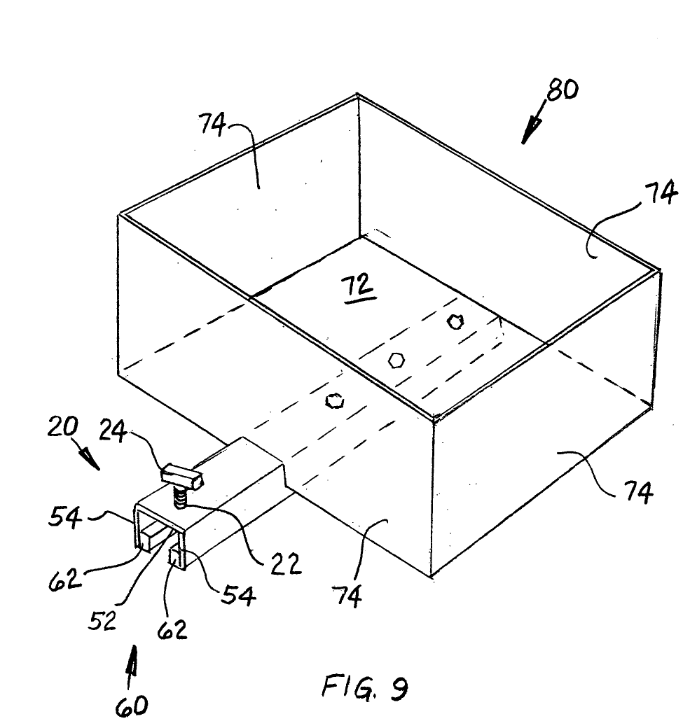

The means 20 for securing the apparatus to a motorcycle hitch includes a ball hitch receiver 18 engageable with the ball hitch of a motorcycle. FIGS. 5, 8 and show an embodiment where such means 20 also includes an aperture 22 and a pin 24 for securing the apparatus 10 to a motorcycle hitch wherein the hitch disposed on the motorcycle is a pin type hitch.

The apparatus 10 also includes a means 30 for covering the items carried in the apparatus to protect the items from rain and other elements. Such means 30 includes a tarp 26. Such tarp 26 can be connected to the top member 6 so that the tarp is automatically pulled up so as to cover the items when the upright sections 4 are extended.

In a second aspect the present invention provides an apparatus 50 for connecting a storage compartment to a hitch disposed on at least one of a motorcycle, an automotive type vehicle and a tractor. The apparatus 50 comprises an elongated C-shaped channel member 52 having each of a predetermined length and a predetermined width, each leg 54 of the elongated C-shaped channel member 52 having a predetermined width. A first means 60 is disposed at one end on an inner surface of each leg 54 of the C-shaped channel member 52 for preventing vertical movement of the storage compartment attached to an upper surface of the C-shaped channel member 52 during use and there is a second means 70 disposed closely adjacent one end of the elongated C-shaped channel member for securing the elongated C-shaped channel member to such hitch disposed on at least one of a motorcycle, an automotive type vehicle and a tractor.

The first means 60 includes a shoulder member 62 disposed on an inner surface at one end of each leg 54 of the C-shaped channel member 52. When the hitch disposed on the at least one of a motorcycle, an automotive type vehicle and a tractor includes an aperture then such second means 70 also includes an aperture 22 and a bolt 24 for securing the elongated C-shaped channel member 52 to such hitch disposed on at least one of a motorcycle, an automotive type vehicle and a tractor. Such second means also includes a stabilizer bar 64 having one end disposed on an underside of the C-shaped channel member 52 and a second end engageable with an underside of such hitch disposed on at least one of a motorcycle, an automotive type vehicle and a tractor for restricting movement of said storage compartment.

When the hitch disposed on at least one of a motorcycle, an automotive type vehicle and a tractor includes a ball then the second means 70 includes an elongated U-shaped slot 66 and a ball receiver 18 for securing the C-shaped channel member 52 to such ball hitch on one of a motorcycle, an automotive type vehicle and a tractor. Such second means 70 further includes a stabilizer bar 64 having one end disposed on an underside of the C-shaped channel member 52 and the second end engageable with an underside of such ball hitch that is disposed on at least one of a motorcycle, an automotive type vehicle and a tractor for restricting movement of the storage compartment.

In yet another aspect of the invention there is provided in combination with a hitch disposed on at least one of an automotive type vehicle and a tractor an apparatus 80 for providing additional storage. The apparatus 80 comprises a base member 72 having a predetermined shape and formed of a predetermined material. A plurality of wall members 74 are engageable with the base member 72 and there is a means 20 engageable with the base member 72 for securing the apparatus 80 to a hitch of such at least one of an automotive type vehicle and a tractor. When used in conjunction with a tractor the wall members can be solid since there is no need to worry about the speed creating wind problems with the storage unit.

Thus, the present invention provides a new means for utilizing the use of a motorcycle by adding additional storage space to the bike. This additional space can enable motorcycle users to use the cycle where otherwise a larger vehicle such as an automobile or truck would have to be used such as going golfing, hunting or fishing. It can even permit the bike to be used on some trips by being able to carry additional luggage for short stays which would not be possible with just the saddlebags for storage. Since the motorcycle uses significantly less gasoline than other vehicles it can be a great cost reduction as well as conserving fuel. With the high cost of gasoline today and with the forecast that it will remain high or go even higher any reduction in the cost to a user is beneficial.

One other item that should be mentioned, although not shown on the drawing figures, as with any trailer or extension to a vehicle, wiring to add taillights to the unit are a prerequisite. Also a place to mount the license plate that is normally on the back of the motorcycle will be made on the back of the storage unit so that the license plate can be moved there when the present invention is in use.

It should be noted that the unit in conjunction with a motorcycle does have weight limits for safety reasons. It is recommended that there not be anything stored on the storage module with a motorcycle that is greater than 100 pounds. Even somewhat less that 100 pounds is desirable. Since this unit is primarily designed for items such as golf bags with clubs or fishing or hunting equipment there is generally no problem with the weight limitation. However, if the storage unit is loaded with luggage items for two when going on a trip then the weight limitations could come into play.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. An apparatus for providing additional storage for use with a motorcycle, said apparatus comprising:
(a) a base member having a predetermined shape and formed of a predetermined material;
(b) a plurality of upright sections engageable on a first end with said base member;
(c) a top member engageable with an upper surface of a second end of said plurality of upright sections; and
(d) a means engageable with said base member for securing said apparatus to a hitch of a motorcycle.

2. The apparatus, according to claim 1, wherein said predetermined shape of said base member is one of rectangular, hexagonal, octagonal and circular.

3. The apparatus, according to claim 2, wherein said predetermined shape of said base member is substantially circular.

4. The apparatus, according to claim 1, wherein said predetermined shape of said base member further includes an upwardly extending lip member formed integrally therewith.

5. The apparatus, according to claim 4, wherein said plurality of upright sections are engageable with an inner surface of said lip member.

6. The apparatus, according to claim 1, wherein said upright sections are disposed substantially uniformly around a perimeter of said base member.

7. The apparatus, according to claim 6, wherein said upright sections are telescoping.

8. The apparatus, according to claim 7, wherein said apparatus is at least sufficiently tall with said upright sections extended to hold a golf bag with clubs.

9. The apparatus, according to claim 1, wherein said apparatus further includes a supporting member, said supporting member being a band having a predetermined width engageable with an outer surface of said plurality of upright sections at a distance intermediate said base member and said top member.

10. The apparatus, according to claim 1, wherein said means for securing said apparatus to a motorcycle hitch includes a ball hitch receiver engageable with a ball hitch of a motorcycle.

11. The apparatus, according to claim 7, wherein said upright section include snap buttons to control said telescoping.

12. The apparatus, according to claim 1, wherein said apparatus further includes a means for covering items carried in said apparatus to protect such items from weather.

13. An apparatus for connecting a storage compartment to a hitch disposed on at least one of a motorcycle, an automotive type vehicle and a tractor, said apparatus comprising:
(a) an elongated C-shaped channel member having each of a predetermined length and a predetermined width, each leg of said elongated C-shaped channel member having a predetermined width;
(b) a first means disposed at one end on an inner surface of each said leg of said C-shaped channel member for preventing vertical movement of said storage compartment attached to an upper surface of said C-shaped channel member during use; and
(c) a second means disposed closely adjacent said one end of said elongated C-shaped channel member for securing said elongated C-shaped channel member to such hitch disposed on at least one of a motorcycle, an automotive type vehicle and a tractor.

14. The apparatus, according to claim 13, wherein said first means includes a shoulder member disposed on an inner surface at said one end of said each leg of said C-shaped channel member.

15. The apparatus, according to claim 13, wherein such hitch disposed on at least one of a motorcycle, an automotive type vehicle and a tractor includes an aperture and said second means includes an aperture and a bolt for securing said elongated C-shaped channel member to such hitch disposed on at least one of a motorcycle, an automotive type vehicle and a tractor.

16. The apparatus, according to claim 13, wherein said second means further includes a stabilizer bar having one end disposed on an underside of said C-shaped channel and a second end engageable with an underside of such hitch disposed on at least one of a motorcycle, an automotive type vehicle and a tractor for restricting movement of said storage compartment.

17. The apparatus, according to claim 13, wherein such hitch disposed on at least one of a motorcycle, an automotive type vehicle and a tractor includes a ball and said second means includes an elongated U-shaped slot and a ball receiver for securing said c-shaped channel to such ball hitch.

18. The apparatus, according to claim 17, wherein said second means further includes a stabilizer bar having one end disposed on an underside of said C-shaped channel and a second end engageable with an underside of such ball hitch disposed on at least one of a motorcycle, an automotive type vehicle and a tractor for restricting movement of said storage compartment.

19. In combination with a hitch disposed on at least one of an automotive type vehicle and a tractor an apparatus for providing additional storage, said apparatus comprising:
(a) a base member having a predetermined shape and formed of a predetermined material;
(b) a plurality of wall members engageable with said base member; and
(c) a means engageable with said base member for securing said apparatus to a hitch of such at least one of one an automotive type vehicle and a tractor.
